(19) United States
(12) Patent Application Publication
(10) Pub. No.: US 2022/0355210 A1
(43) Pub. Date: Nov. 10, 2022

(54) VIRTUAL SPORTS DEVICE AND VIRTUAL SPORTS SYSTEM

(71) Applicant: SGM CO., LTD., Seongnam-si (KR)

(72) Inventors: Ui Bum LEE, Seongnam-si (KR); Kap Su KIM, Seoul (KR); So Jin LEE, Seoul (KR)

(21) Appl. No.: 17/730,216

(22) Filed: Apr. 27, 2022

(30) Foreign Application Priority Data
May 6, 2021 (KR) 10-2021-0058688

(51) Int. Cl. A63F 13/812; A63F 13/54; A63F 13/52

(52) U.S. Cl. CPC A63F 13/812; A63F 13/54; A63F 13/52

(57) ABSTRACT

The present invention relates to a virtual sports system and a virtual sports device that may be used in the virtual sports system. The virtual sports system comprises a terminal device, a service device accessible by the terminal device and a virtual sports device communicatively connected to the service device, wherein when a user requests to provide content through the terminal device, information on the requested content is delivered to the virtual sports device through the service device, and the virtual sports device provides the content to another user playing in the virtual sports device.

### CROSS-REFERENCES TO RELATED APPLICATIONS

The present application is related to the Korean Patent Application No. 10-2021-0058688, filed May 6, 2021, the entire disclosure of which is expressly incorporated by reference herein.

### BACKGROUND OF THE INVENTION

### 1. Field of the Invention

The present invention relates to a virtual sports device and a virtual sports system.

### 2. Description of the Related Art

Recently, as interest in sports has increased, the number of people who enjoy sports is increasing. As for sports, the popularity of virtual indoor sports using virtual sports devices is growing. For example, in screen baseball or screen golf that is one of virtual indoor sports using virtual sports devices, images of a baseball field or a golf course are displayed on a screen. Therefore, it can give the feeling of playing a real sports game outside, and time and money can be saved in comparison with the play at an outdoor field. As a result, indoor sports using virtual sports devices are very popular among busy modern people who have difficulty in playing a real outdoor game due to time or economic reasons, etc.

As the number of screen sports users increases, users' expectations are increasing. Screen sports using the virtual sports devices need to provide the same reality as if playing in a real sports stadium. In addition, they need to enhance the interest of users by providing a variety of content that it is difficult to provide in real sports venues due to the nature of a service.

### BRIEF SUMMARY OF THE INVENTION

In order to solve the above-mentioned problems, the present invention provides a virtual sports system that enables another user to provide content to a user who is currently playing virtual sports so that the interest of the user in virtual sports play can be increased.

The present invention also provides a virtual sports device that may be used in the virtual sports system.

The other objects of the present invention will be clearly understood with reference to the following detailed description and the accompanying drawings.

In order to achieve the above-mentioned objects, a virtual sports system according to an embodiment of the present invention comprises a terminal device, a service device accessible by the terminal device and a virtual sports device communicatively connected to the service device. When a user requests to provide content through the terminal device, information on the requested content is delivered to the virtual sports device through the service device, and the virtual sports device provides the content to another user playing in the virtual sports device.

In the virtual sports system, the virtual sports device comprises a display portion displaying a sports image and a sound portion generating sound, and the content comprises at least one of visual content provided by the display portion and audio content provided by the sound portion.

In the virtual sports system, the virtual sports device further comprises a controller controlling operations of the display portion and the sound portion and a storage portion storing a plurality of pieces of content, and the controller extracts the content requested by the user from the storage portion to deliver the extracted content to at least one of the display portion and the sound portion.

In the virtual sports system, the virtual sports device may operate according to any one of a first method in which there is a limitation in providing the content and a second method in which there is no limitation in providing the content.

In the virtual sports system, the limitation in providing the content may comprise a limitation on at least one of a type of the content and a time of providing the content.

In the virtual sports system, the content may comprise at least one of content representing a user's emotion, content cheering the user, content disrupting a user's play and content including advertisement.

A virtual sports device according to an embodiment of the present invention, which is communicatively connected to a service device accessible by a terminal device, comprises a display portion displaying a sports image, a sound portion generating sound, a controller controlling operations of the display portion and the sound portion and a storage portion storing a plurality of pieces of content. When a user requests to provide content through the terminal device, information on the requested content is delivered through the service device and provided to another user playing in the virtual sports device.

According to the present invention, another user can provide content to a user who is currently playing virtual sports so that the interest of the user in virtual sports play can be increased.

### BRIEF DESCRIPTION OF THE DRAWINGS

FIG. 1 shows a schematic structure of a virtual sports system according to an embodiment of the present invention.

FIG. 2 is a view illustrating an example of a terminal device of FIG. 1.

FIGS. 3 to 5 are views illustrating various examples of a virtual sports device of FIG. 1.

FIG. 6 is a flowchart of a content provision process.

FIGS. 7 to 9 are views concretely showing respective steps in the content provision process of FIG. 6.

FIGS. 10 to 16 show various implementation examples related to content provision.

### DETAILED DESCRIPTION OF THE INVENTION

Hereinafter, a detailed description will be given of the present invention with reference to the following embodiments. The purposes, features, and advantages of the present invention will be easily understood through the following embodiments. The present invention is not limited to such embodiments but may be modified in other forms. The embodiments to be described below are nothing but the ones provided to bring the disclosure of the present invention to perfection and assist those skilled in the art to completely understand the present invention. Therefore, the following embodiments are not to be construed as limiting the present invention.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. It will be understood that when an element is referred to as being “on” another element, it can be directly on the other element or intervening elements may be present therebetween.

The size of the element or the relative sizes between elements in the drawings may be shown to be exaggerated for more clear understanding of the present invention. In addition, the shape of the elements shown in the drawings may be somewhat changed by variation of the manufacturing process or the like. Accordingly, the embodiments disclosed herein are not to be limited to the shapes shown in the drawings unless otherwise stated, and it is to be understood to include a certain amount of variation.

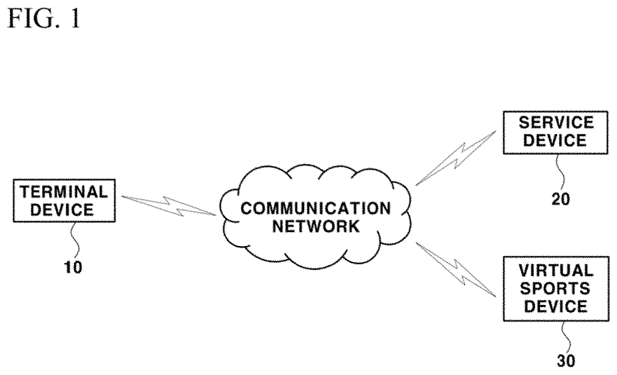

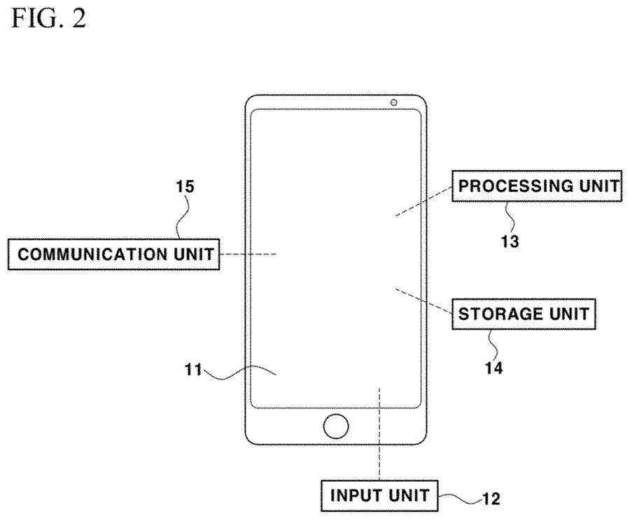

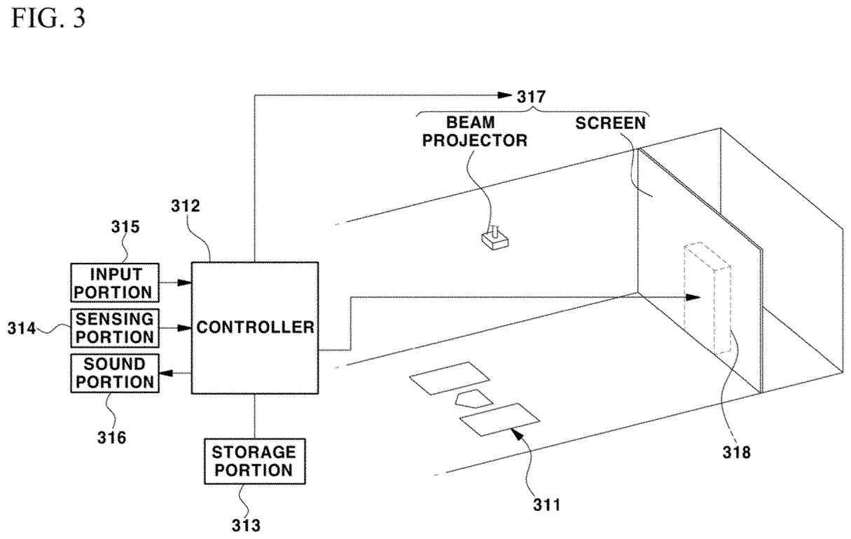

FIG. 1 shows a schematic structure of a virtual sports system according to an embodiment of the present invention, FIG. 2 is a view illustrating an example of a terminal device of FIG. 1, and FIGS. 3 to 5 are views illustrating various examples of a virtual sports device of FIG. 1.

Referring to FIG. 1, the virtual sports system comprises a terminal device 10, a service device 20, and a virtual sports device 30. The terminal device 10 has a device where a remote server is accessible using a communication network. For example, as the terminal device 10, a smartphone, a desktop computer, a tablet computer, a notebook computer, etc., which are equipped with a web browser, may be used. The service device 20 may be a server operated by a service provider providing a service of the virtual sports system. Examples of the communication network may include the Internet, Local Area Network (LAN), Wireless Local Area Network (Wireless LAN), Wide Area Network (WAN), 3, 4G, 5G, Wi-Fi, Li-Fi, etc. The virtual sports device 30 is connected to the service device 20 through a communication network or the like. By the virtual sports device 30, users can play various types of sports, such as golf, baseball, and soccer. There may be a single virtual sports device 30 or a plurality of devices.

Referring to FIG. 2, as an example of the terminal device 10, a mobile device such as a user's smartphone may be used. As illustrated in FIG. 2, the smartphone includes a display unit 11, an input unit 12, a processing unit 13, a storage unit 14, a communication unit 15, and the like. The display unit 11 includes a display device and displays various types of information. The input unit 12 is used to input a command of a user by a method such as a touch screen. The processing unit 13 includes a central processing unit (CPU), or the like, used for executing an operating program of the terminal device 10 or various applications. The storage unit 14 includes a memory device such as a memory and stores various programs and data. The communication unit 15 includes various types of communication devices used to communicate with external devices.

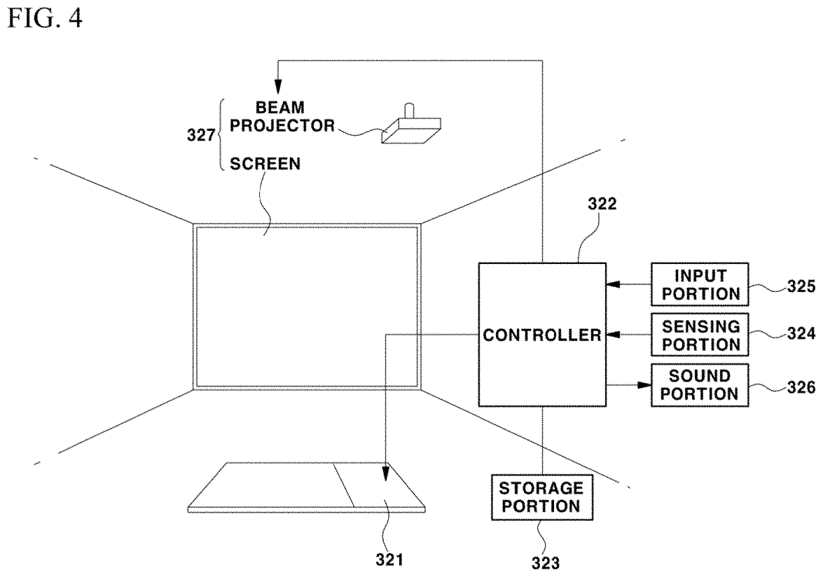

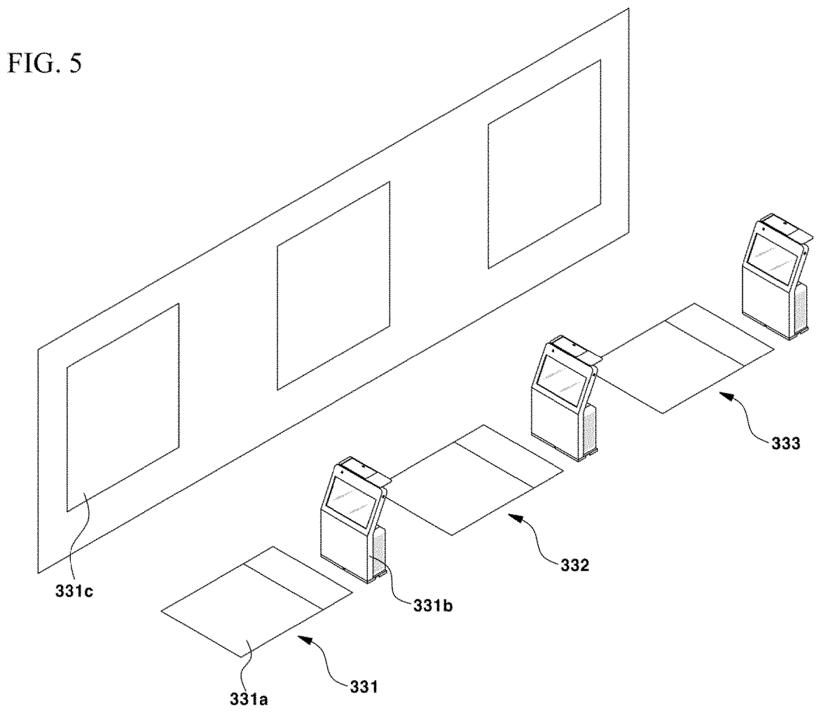

As illustrated in FIGS. 3 to 5, examples of the virtual sports device 30 may include a virtual baseball device (FIG. 3) or a virtual golf device (FIGS. 4 and 5).

Referring to FIG. 3, the virtual baseball device comprises a hitting plate 311, a controller 312, a storage portion 313, a sensing portion 314, an input portion 315, a sound portion 316, a display portion 317, and a ball pitching portion 318.

The hitting plate 311 represents a hitting zone in which a user is positioned to hit a ball. The controller 312 is in charge of various calculations and controls necessary for the overall operation of the virtual baseball device. In addition, the controller 312 performs a calculation process of calculating what kind of hitting result (a ground ball, a fly, a hit, a home run, etc.) will be when the user hits a ball, assuming that the hit ball moves in an actual baseball field. The storage portion 313 includes a storage device such as a memory or a hard disk, and stores various programs or data necessary for the operation of the controller 312. The sensing portion 314 includes a sensing unit for detecting the physical state of a ball to sense a physical state of the ball hit by the user such as a moving speed and a moving direction. As the sensing unit of the sensing portion 314, various sensors or cameras may be used, and information sensed by the sensing portion 314 is transmitted to the controller 312, and the controller 312 may perform the calculation process of calculating a hitting result based on the received information. The input portion 315 is for receiving various types of information from the user, and a keyboard or mouse may be used. In screen baseball in which a virtual baseball device is used, a login system that requires login by a user before providing a service may be applied. When the login system is applied, the input portion 315 may be used by the user to input the user's ID or password. In addition, the input portion 315 may be used when the user selects a baseball field or a play level in screen baseball. The sound portion 316 may include a sound device such as a speaker, and is used to inform the user of the progress of a game and reproduce various sound effects according to the progress of the game. The display portion 317 includes devices such as a beam projector and a screen. The beam projector projects a baseball-related image on the screen such that a baseball field and baseball players are displayed on the screen, and the screen displays the projected baseball-related image to the user. For example, when the user hits a ball and the controller 312 calculates a result of the hitting by performing the calculation process, an image showing a result of the calculation is displayed on the screen. The ball pitching portion 318 includes a device that fires a ball so that the user may hit the ball. Although not illustrated in the drawing, a through hole is formed in the screen, and the ball fired from the ball pitching portion 318 passes through the through hole to reach the user. The controller 312 controls an operation of the ball pitching portion 318 such that a ball is fired in time when the user is ready to hit the ball on hitting plate 311.

Referring to FIG. 4, the virtual golf device comprises a hitting plate 321, a controller 322, a storage portion 323, a sensing portion 324, an input portion 325, a sound portion 326, and a display portion 327.

The hitting plate 321 is a zone where a user is positioned to hit a golf ball, and the hitting plate 321 is provided with a hitting mat, and the user places the golf ball on the hitting mat and hits the golf ball. Although not illustrated in the drawing, an auto tee having a vertically movable structure is installed on the hitting mat, and a golf ball for hitting may be automatically provided to the user through the auto tee. The controller 322 controls the overall operation between each component of the virtual golf device. For example, the controller 322 controls the auto tee installed on the hitting mat, and operates such that a golf ball for hitting is provided from the auto tee according to a hitting timing of a user. In addition, when the user selects a certain golf course, the controller 322 performs a necessary operation so that the user can play the selected golf course. That is, the controller 322 includes an image processing unit for processing an image, and when the user selects a certain golf course, the image processing unit can form an image of the selected golf course to transmit it to the display portion 327 so that the image of the selected golf course is displayed by the display portion 327. In addition, a login system that requires a login by a user before providing a service may be applied to screen golf in which a virtual golf device is used, and when the user inputs personal information such as an ID or password for login, the controller 322 may transmit the input personal information to the service device 20 to determine whether to approve the login. In addition, the controller 322 performs a calculation process of calculating a flight trajectory of a golf ball hit by the user based on a physical state of the golf ball when it is assumed that the golf ball actually flies on the real golf course in the sensed state of the golf ball. The storage portion 323 includes a storage device such as a memory or a hard disk, and stores various programs or data necessary for the operation of the controller 322. The sensing portion 324 is used to detect the movement of a golf club or the movement of a golf ball hit by the user to detect physical state information about the hit golf ball, and a sensing unit such as a camera or a sensor capable of photographing the movement of the golf club or the golf ball may be used. Various sensing methods such as image sensing, light emission/reception sensing, and laser sensing may be applied to the sensing unit. The state information of a golf club or a golf ball hit by the user can be detected by those sensing methods. The camera or the sensor may be used alone or used together, and only one sensing unit may be used or several sensing units may be used if circumstances need. Information obtained through the sensing portion 324 is transmitted to the controller 322 and used in the calculation process. The input portion 325 is used to receive various types of information from the user, and a keyboard or mouse may be used. The input portion 325 is used when the user inputs his/her ID or password for log-in, or when the user selects a golf course or a play level, etc. The sound portion 326 may include a sound device such as a speaker, and is used to inform the user of the progress of a game and reproduce various sound effects according to the progress of the game. The display portion 317 includes a beam projector and a screen. The beam projector projects a golf-related image on the screen in order that a golf course and a golf ball are displayed on the screen, and the screen displays the projected golf-related image to the user. Hereinafter, some objects displayed on the screen may be expressed by using the term ‘virtual’. This means that it does not exist in the real world and is displayed on the screen. For example, ‘virtual golf course’ means a golf course displayed on the screen and ‘virtual golf ball’ means a golf ball displayed on the screen.

By using the virtual golf device, the user can play screen golf. When the user plays screen golf, the virtual golf device operates as follows. When the user hits a golf ball, the sensing portion 324 senses a physical state such as the movement of a golf club or a moving speed or a moving direction of the golf ball hit by the user. Information sensed by the sensing portion 324 is transmitted to the controller 322, and the controller 322 performs a calculation process based on the received information. The display portion 327 displays an image of a virtual golf ball moving according to a trajectory calculated in the calculation process, and the virtual golf ball flies along the calculated trajectory and then lands at a certain point in the virtual golf course in the screen, and the user continues with a next hitting at the point where the virtual golf ball has landed.

The virtual golf device may have a structure illustrated in FIG. 4 or other structures. For example, referring to FIG. 5, another type of virtual golf device may include a plurality of personal booths 331, 332, and 333. A first personal booth 331 may include a hitting plate 331a, a simulator 331b including a kiosk screen, a screen 331c, and the like, and the other personal booths 332 and 333 have the same components. Although not shown in the drawing, each of the personal booths 331, 332, and 333 can further include other devices such as a camera for detecting the movement of a golf ball. The virtual golf device according to the present embodiment may be used by a user to play golf alone, and the user can enjoy playing golf alone while being separated from other users in each of the personal booths 331, 332, and 333. However, in the virtual golf device according to the present embodiment, each of the personal booths 331, 332, and 333 does not necessarily have to be used by only a single user, and can also be used by several acquaintances alternately.

According to the present invention, when a user is playing using a virtual sports device such as the virtual baseball device or the virtual golf device, another user may provide various contents to the playing user. A process of providing the contents may be applied to baseball, golf, and other sports devices. Here, a content providing process is described using a virtual golf device as an example.

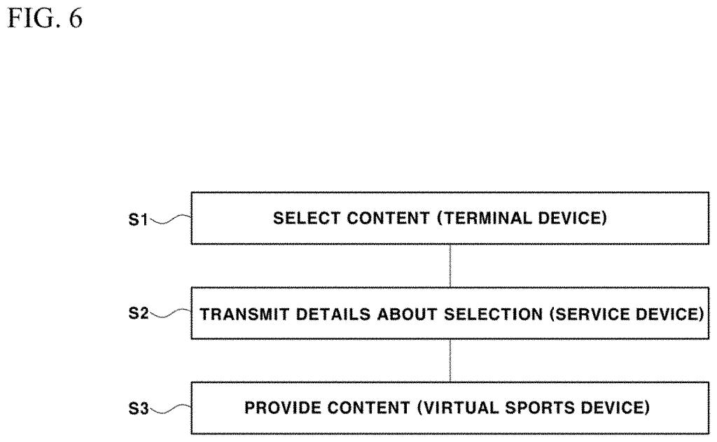

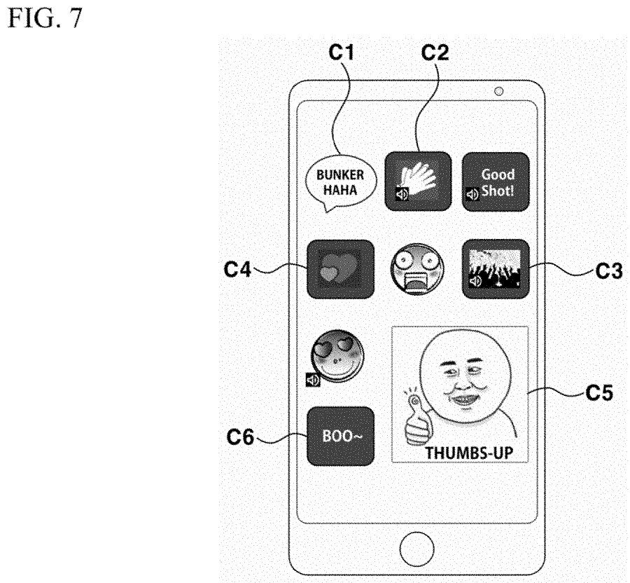

FIG. 6 is a flowchart of a content provision process, and FIGS. 7 to 9 are views concretely showing respective steps in the content provision process of FIG. 6.

Referring to FIG. 6, the content providing process may include a first operation 51 of selecting content, a second operation S2 of transmitting details about the selection, and a third operation S3 of providing the selected content. As the content providing process may be performed in the virtual sports system illustrated in FIG. 1, reference numerals shown in FIGS. 1 to 5 may be used in the following description.

Referring to FIG. 7, in the first operation 51, a user may select content to be provided to another user in the terminal device 10 such as a smartphone. In order to select content, a program provided by a service provider is to be installed in the terminal device 10, and when the program is installed and then executed, a picture for selecting various contents may be displayed. In some cases, when the program is executed, it may be necessary to execute login of a user on the service device 20. For example, if users pay fees for some of the contents, the users' identity should be first identified through login before displaying the contents owned by the users since each user may have different contents. When the contents owned by a user are displayed on the terminal device 10, the user may execute a command for selecting the content to be provided to another user by touching any one of a plurality of pieces of displayed contents.

The content has various forms and meanings. For example, in regard to the form of the content, there may be visual content (C1) that is visually recognized, like “bunker haha”, audio content (C2) that provides sound like applause, and content (C3) in which visual content and audio content are combined. For example, in the combined content (C3), a scene where people are cheering and a cheering sound can be provided together. In addition, in regard to the meanings of the content, there may be content (C4) that expresses the user's emotions such as a heart shape, content (C5) that encourages a user who is currently playing by raising a thumb, content (C6) that interrupts the play of the user who is currently playing by booing, and the like. FIG. 7 illustrates some examples of content in various forms and meanings, and various contents not shown here may be used.

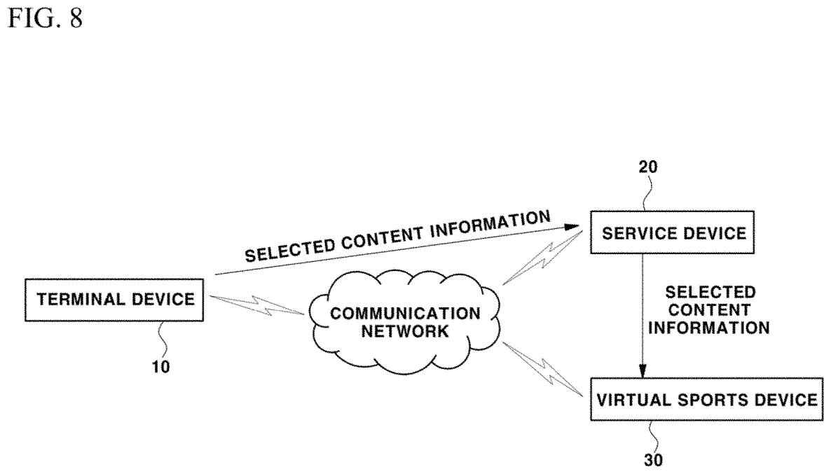

Referring to FIG. 8, in the second operation S2, information about the content selected by the user is transmitted. When the user selects certain content in the terminal device 10 and executes a command to request the content to be provided to another user, information about the selected content is transmitted to the service device 20, which is connected to the terminal device 10 through a communication network, and the service device 20 transmits the information to the virtual sports device 30. When there is only one virtual sports device 30, the selected content information may be directly transmitted to the corresponding virtual sports device 30 through the above process. In addition, when there are a plurality of virtual sports devices 30, when a user who wants to provide content (content provider) and a user who receives content (content user) log in and play together on the same virtual sports device 30, the selected content information may be transmitted to a corresponding virtual sports device 30 through the above process. When there are multiple virtual sports devices 30 and the content provider is not on the virtual sports device 30 that the content user is playing, the content provider may select content to be provided and at the same time designate a content user (for example, by additionally inputting ID of the content user). In a virtual sports system including a plurality of virtual sports devices 30, when a content user inputs login information for login by using a certain virtual sports device, the login information is transmitted to the service device 20, and the service device 20 checks the received login information to determine whether to approve the login. Due to this login process, the service device 20 can know which of the plurality of virtual sports devices 30 the content user logged in to. Therefore, when the content provider designates a content user and selects content to be provided, information about the selected content can be transmitted to the virtual sports device 30, at which the content user is located.

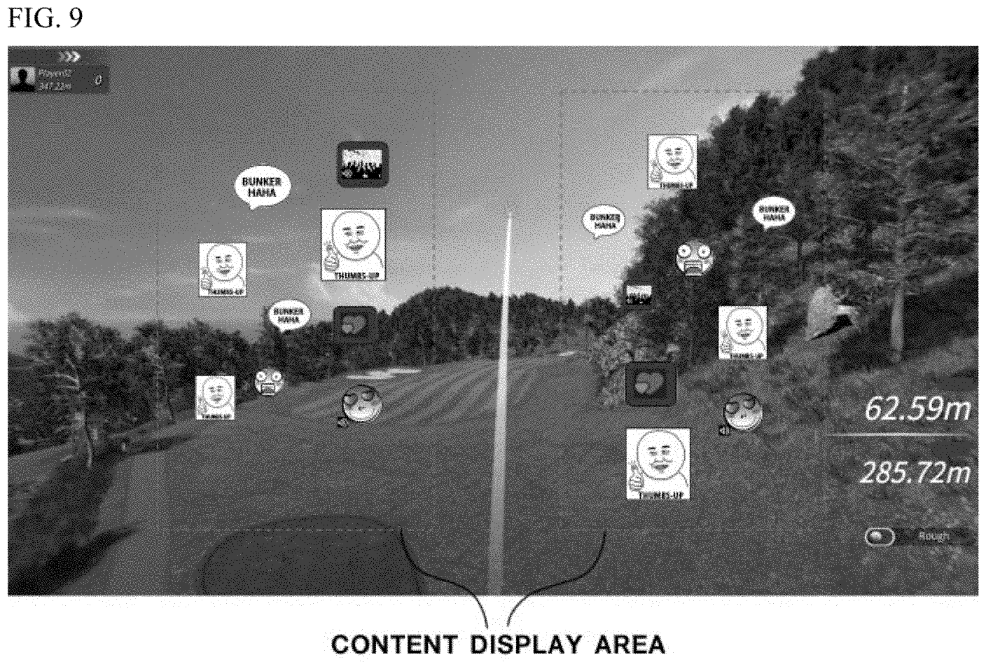

Referring to FIG. 9, in the third operation S3, the virtual sports device 30 receives content-related information and then provides the content to the content user. When the virtual sports device 30 is a virtual golf device, the content-related information is transmitted to the controller 322, and the controller 322 may search content data stored in the storage portion 323 and extract the content selected by the content provider, and then provide the extracted content to the content user through the sound portion 326 and/or the display portion 327. Alternatively, the controller may directly extract the content selected by the content provider from the content-related information and then provide the extracted content to the content user through the sound portion 326 and/or the display portion 327 without searching content data stored in the storage portion 323.

The virtual golf device calculates a trajectory of a golf ball hit by a content user when the content user hits the golf ball, and the calculation result is displayed on a screen. As illustrated in FIG. 9, the golf ball flying according to the calculation result is displayed mainly in a center portion of a golf course displayed on the screen. Since a user who has hit a golf ball is interested in a flight image of the golf ball, among the flight image of the golf ball and the image of the golf course, the former is a main image and the latter is a sub-image. Content that the content provider intends to provide is not directly related to golf play itself, and thus, it is preferable that the content is displayed in a region in which the sub-image is displayed rather than in a region of the main image. Only one piece or a plurality of pieces of content sent by the content provider can be displayed. In addition, only one type of content can be displayed or several types of content can be displayed together. Also, when there are a plurality of users who want to provide content, the content provided by the plurality of users may be sequentially provided or provided all together. In case of visual content expressed visually, it is preferable that a content display area is set in a region of the screen in which the sub-image is shown and the visual content is displayed in the content display area set. In case of audio content, it can be provided through a sound device such as a speaker. However, the visual content does not necessarily have to be displayed only in the region where the sub-image is shown, and can be displayed in a region where the main image is shown at the center of the screen.

The method described with reference to FIGS. 6 to 9 shows an example of providing content, and various modifications may be made to an interface, an expression method, and an operating method related to provision of contents. Some of these modifications are described by taking the case where a virtual sports device is a virtual golf device as an example. However, the description provided below can also be applied to a virtual baseball device or other virtual sports devices.

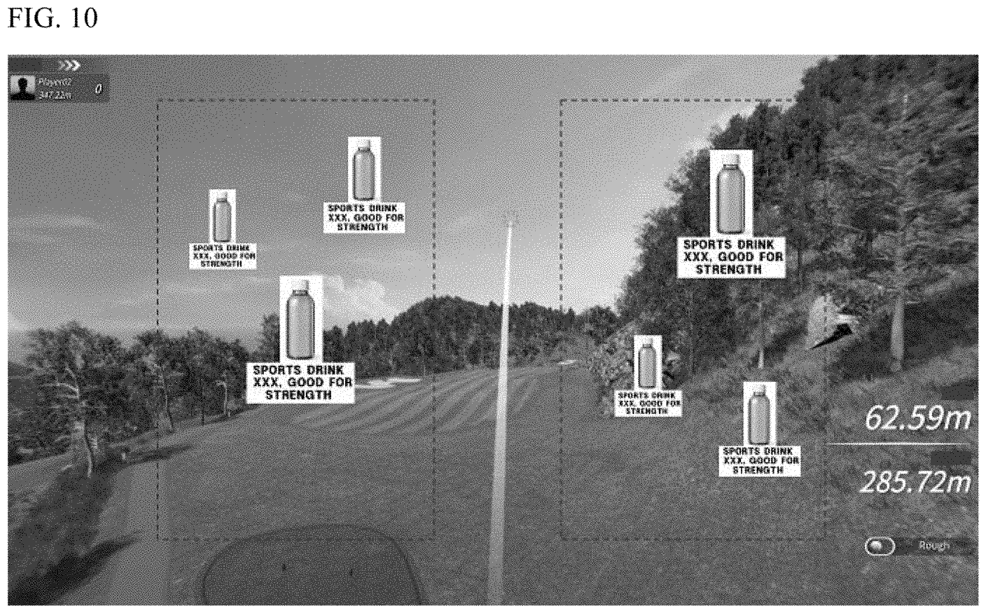

FIGS. 10 to 16 show various implementation examples related to content provision.

When content is displayed on the virtual golf device, the content may include advertisement content. For example, when content is displayed along with a flying golf ball, as illustrated in FIG. 10, an image of a drink product may be displayed as content. In addition, a promotional message saying that the product can give the power to blow a long shot (for example, phrases such as “sports drink XXX, good for strength”) may be added to the image of the drink product. The advertisement content may be introduced according to a contract between an advertiser and an operator of a service device. In addition, depending on the details of the contract, benefits (for example, a discount on virtual golf device usage fees, etc.) may be given to users who use the advertisement content, and the cost incurred when providing the benefits may be borne by the advertiser.

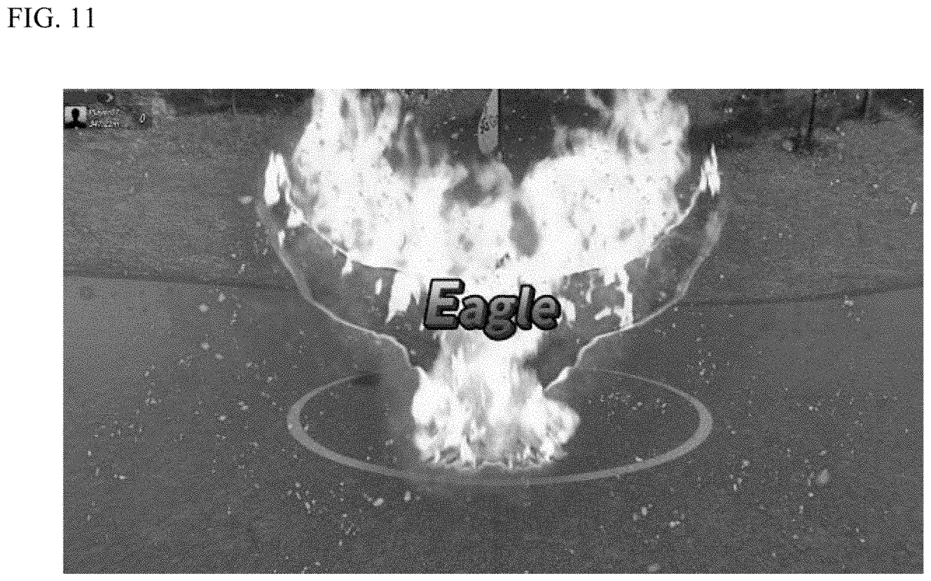

Referring to FIG. 11, when a content user achieves a specific ‘performance’ by hitting a golf ball, content directly indicating the details of the performance may be displayed. For example, when a content user has achieved an eagle meaning that strokes used for taking a golf ball into a hole cup are two less than par, content having a firebird image with a bird image resulting from ‘eagle’ and a flame image giving a strong impression can be displayed so that it is possible to deliver a powerful congratulatory message to the content user for achieving ‘eagle’. Content, such as the ‘firebird’ image, which is related to a hitting result of a currently playing content user, may be provided upon request from a content provider or may be preset in advance to be automatically provided when the corresponding hitting result is obtained.

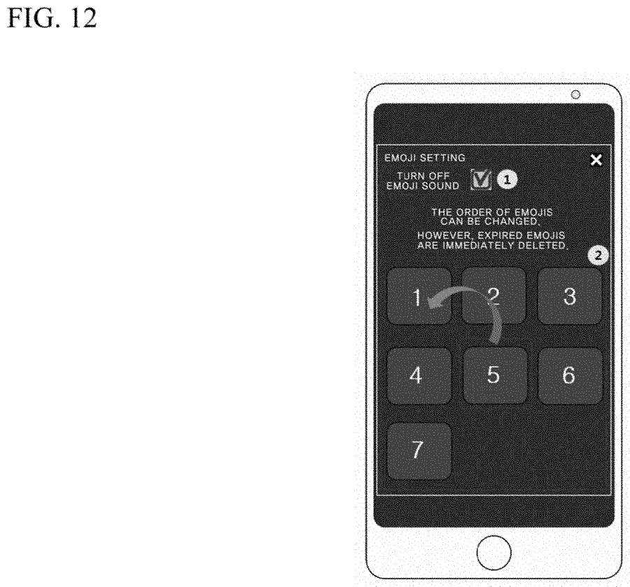

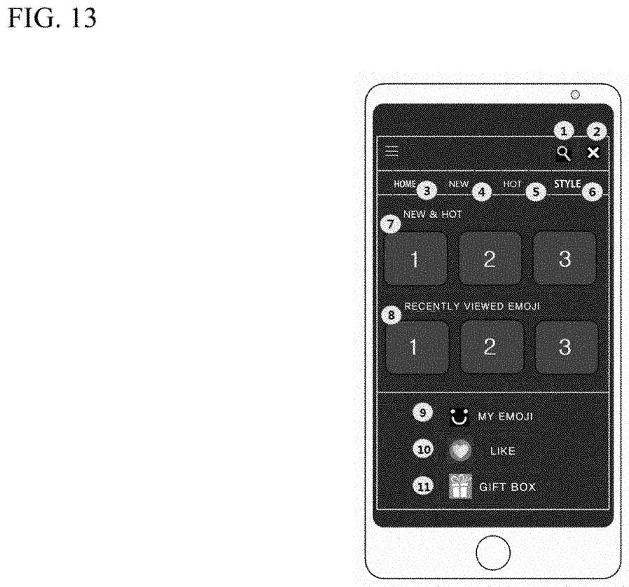

In a terminal device, various types of user interfaces can be provided in relation to content. For example, when a smartphone is used as a terminal device, as illustrated in FIG. 12 (the term ‘emoji’ is described in FIGS. 12 and 13 as a term for ‘content’, which is an arbitrarily created term), the smartphone can be provided with an interface for content setting. A sound on/off function (1), which is a function of turning on or off sound effects with respect to a plurality of pieces of content having sound effects, a function of changing the order of displaying a plurality of pieces of content (2), or the like may be provided through the interface for content setting. In addition, as illustrated in FIG. 13, the smartphone may be provided with an interface through which a user can purchase content for a fee or for free, and through the interface, a function of searching for content name (1), a function of closing a store for purchasing content (2), a function of listing new/popular contents, recently viewed contents, user-owned contents, etc. at a glance (3), a new content list function (4), a popular content list function (5), a content list function by style (6), a function of randomly recommending new and popular contents (7), a recently viewed contents list function among unpurchased contents (8), a user-owned contents list function (9), a function of listing liked contents (10), a gift box function (11), or the like may be provided.

In regard to a content providing method, a certain limitation may be placed on content provision or content may be provided without limitation. Hereinafter, for convenience of description, a method in which limitations are put on content provision is referred to as a first method, and a method in which content may be provided without limitation is referred to as a second method. A method of operating a virtual golf device where contents are provided according to the first and second methods is particularly effective when a plurality of users play together on a same virtual golf device. The detailed process is as follows.

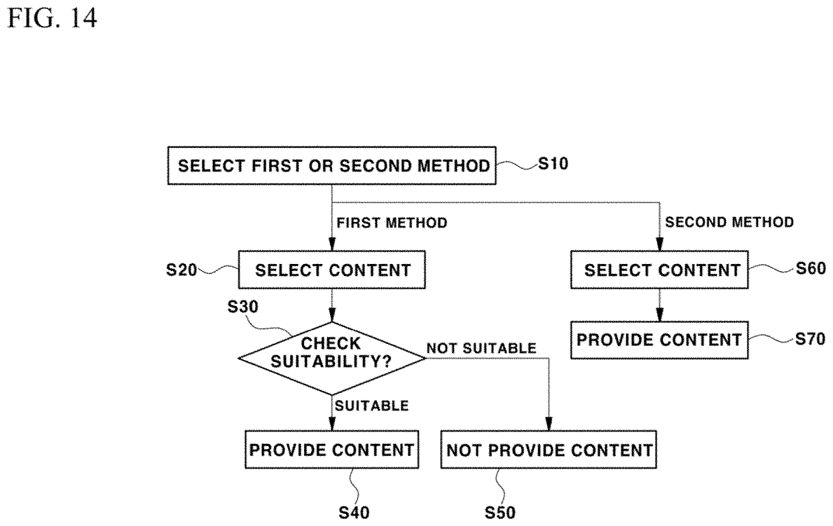

Referring to FIG. 14, in relation to content provision, a user may select a desired method among the first method and the second method in operation S10. When the user selects the first method, another user who is not currently playing golf among a plurality of users may select content to be provided to a user who is currently playing in operation S20, and a controller of the virtual golf device (see reference numeral 322 in FIG. 4) may check whether it is suitable to provide the selected content because there is a limitation on the content provision (S30). As a result of the checking, when it is determined that provision of the selected content is suitable, the content is provided in operation S40, and when it is determined that the provision of the selected content is not suitable, the content is not provided in operation S50. When the user selects the second method, another user who is currently not playing golf from among the plurality of users may select content to be provided to the currently playing user in operation S60, and the controller of the virtual golf device may immediately provide the content, without checking whether it is suitable to provide the content, in operation S70.

In the first method, examples of the limitations on content provision may include limitations on types of content, limitations on a time of providing content, and the like. The limitations on the types of content may include, for example, preventing provision of content booing or criticizing the user who is currently playing. The limitations on the time of providing content may include, for example, preventing provision of content when a high level of concentration is required for play, such as a moment when a currently playing user hits or puts a golf ball. Since a miss of hitting a golf ball greatly affects the performance, a high level of concentration is required when hitting a golf ball, and in this case, providing content may disturb the user who is playing. Taking this into account, in the first method, limitations are placed on the type of content, the time of providing content, and the like, and when the above limitations are applied, other users are prevented from providing content. On the other hand, in the second method, there is no limitation on the type of content or the time of providing the content, and users may freely provide any kind of content at any time. The second method may lead to the obstruction of the play of the user who is currently playing. But the second method is designed to induce the user to concentrate on his or her hitting despite the interruption while acknowledging the interruption as a factor that enhances the fun of the game. For example, in basketball, when a player tries to throw a free throw, sometimes the opposing team's spectators at the back of the goalpost wave their hands in hope of a misthrow, and the player who is throwing a free throw has to overcome the disturbance and focus on to make a score.

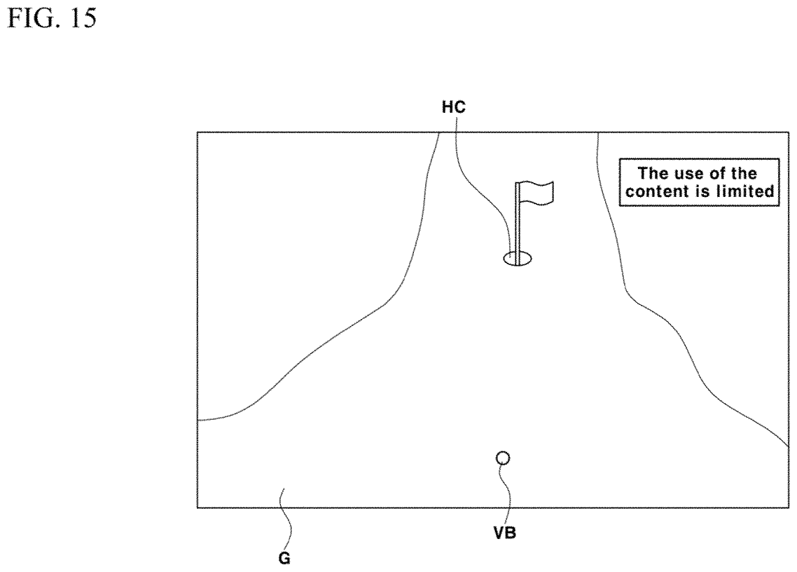

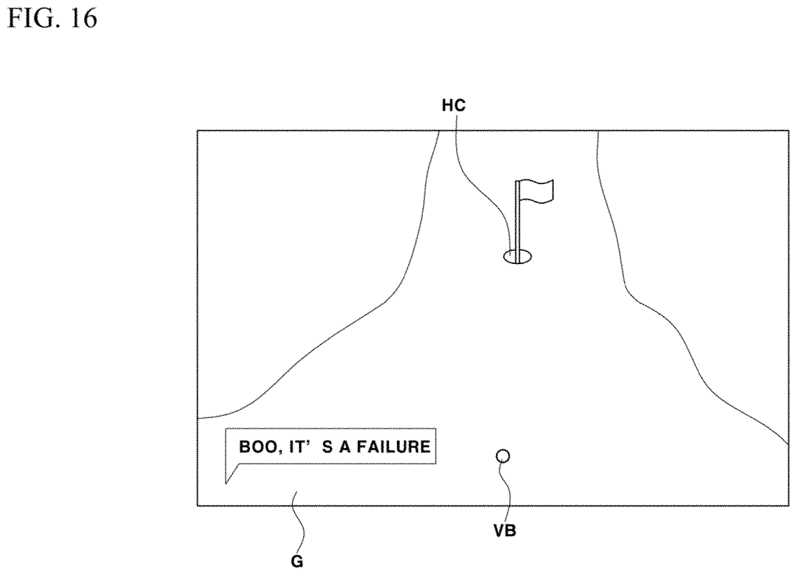

Referring to FIGS. 15 and 16, when a currently playing user prepares to putt, a virtual golf ball VB and a hole cup HC, which is a target point of putting, placed in a green area G, are displayed on a screen. While the first method is being applied, a message indicating that the use of the content is limited may be displayed on the screen. Through the message, it is possible to induce users who are not currently playing to not send unnecessary content to a user who is playing. In contrast, contents may be provided without any limitations while the second method is being applied. As shown in FIG. 16, even in a situation requiring high concentration just before putting, a message or sound content containing a booing expression can be provided. In particular, when a bet is laid between a plurality of users playing screen golf, there may be a great desire for the other person's failure among the plurality of users. In the second method, fun can be added to golf play by disturbing the other person's play.

Although the embodiments of the present invention have been disclosed for illustrative purposes, those skilled in the art will appreciate that the present invention may be embodied in other specific ways without changing the technical spirit or essential features thereof. Therefore, the embodiments disclosed in the present invention are not restrictive but are illustrative. The scope of the present invention is given by the claims, rather than the specification, and also contains all modifications within the meaning and range equivalent to the claims.

What is claimed is:

1. A virtual sports system comprising:
a terminal device;
a service device accessible by the terminal device; and
a virtual sports device communicatively connected to the service device,
wherein when a user requests to provide content through the terminal device, information on the requested content is delivered to the virtual sports device through the service device, and the virtual sports device provides the content to another user playing in the virtual sports device.

2. The virtual sports system of claim 1, wherein the virtual sports device comprises a display portion displaying a sports image and a sound portion generating sound, and the content comprises at least one of visual content provided by the display portion and audio content provided by the sound portion.

3. The virtual sports system of claim 2, wherein the virtual sports device further comprises a controller controlling operations of the display portion and the sound portion and a storage portion storing a plurality of pieces of content, and the controller extracts the content requested by the user from the storage portion to deliver the extracted content to at least one of the display portion and the sound portion.

4. The virtual sports system of claim 1, wherein the virtual sports device operates according to any one of a first method in which there is a limitation in providing the content and a second method in which there is no limitation in providing the content.

5. The virtual sports system of claim 4, wherein the limitation in providing the content comprises a limitation on at least one of a type of the content and a time of providing the content.

6. The virtual sports system of claim 1, wherein the content comprises at least one of content representing a user's emotion, content cheering the user, content disrupting a user's play and content including advertisement.

7. A virtual sports device communicatively connected to a service device accessible by a terminal device comprising:
a display portion displaying a sports image;
a sound portion generating sound;
a controller controlling operations of the display portion and the sound portion; and
a storage portion storing a plurality of pieces of content,
wherein when a user requests to provide content through the terminal device, information on the requested content is delivered through the service device and provided to another user playing in the virtual sports device.
